(19) United States
(12) Patent Application Publication
(10) Pub. No.: US 2002/0074797 A1
(43) Pub. Date: Jun. 20, 2002

(54) Thread joint for percussive drilling and parts therefor

(76) Inventors: Per-Olof Liljebrand, Sandviken (SE); Bertil Ederyd, Gavle (SE)

Correspondence Address: Ronald E. Grudziecki, BURNS, DOANE, SWECKER & MATHIS, L.L.P., P.O. Box 1404, Alexandria, VA, 22313-1404, US

(21) Appl. No.: 09/996,682

(22) Filed: Nov. 30, 2001

(30) Foreign Application Priority Data
Nov. 30, 2000 (SE) 0004419-8

(51) Int. Cl. F16L 25/00

(52) U.S. Cl. 285/333

(57) ABSTRACT

A drill string for percussive rock drilling includes a series of drill string components which are interconnected by thread joints. Each thread joint includes a male portion on a first of the components, and a female portion on a second of the components which receives the male portion of the first component. Each of the male and female portions includes a screw thread structure. Each of the screw thread structures includes a small-diameter thread and a large-diameter thread which are interconnected to one another by a transition thread. Each of the drill string components includes the male portion at one of its ends, and the female portion at the other of its ends.

### BACKGROUND OF THE INVENTION

The present invention relates to a thread joint for percussive rock drilling and parts therefor.

### PRIOR ART

A thread joint for percussive rock drilling is known, for example, from WO 00/19056. The known thread joint includes cooperative conical rope threads intended to improve the strength of the joint. However, the thread will be relatively sensitive to dimensional tolerance faults such that a minor error in tolerances means that the flanks of the thread partly will not come in contact with each other. Furthermore, connection to conventional rock drilling components becomes impossible.

### OBJECTS OF THE INVENTION

One object of the present invention is to provide a thread joint for percussive rock drilling, which minimizes the above-captioned drawbacks.

Another object of the present invention is to provide a thread joint for percussive rock drilling, which can be connected to conventional rock drilling components.

### SUMMARY OF THE INVENTION

These and other objects are realized by means of a thread joint for percussive drilling which comprises first and second drill string components. The first component includes a male portion defining an integral spigot of the first component. The spigot includes an abutment service at a free end thereof and a male thread structure comprising first and second interconnected cylindrical male threads. The first and second male threads have different respective diameters and are interconnected by a male transition thread region. The second component includes a female portion defining an integral sleeve of the second component. The sleeve includes an internal abutment service and a female thread structure which receives the male thread structure. The female thread structure includes first and second interconnected cylindrical female threads. The first and second female threads have different respective diameters and are interconnected by a female transition thread region.

### BRIEF DESCRIPTION OF THE DRAWINGS

FIG. 1 shows a thread joint for percussive drilling according to the present invention in cross-section.

FIG. 2 shows a rock drilling component according to the present invention in cross-section with a male thread.

FIG. 3 shows a rock drilling component according to the present invention in cross-section with a female thread.

FIG. 4 shows a thread joint for percussive drilling between a female portion according to the present invention and a first conventional rock drilling rod in cross-section.

FIG. 5 shows a thread joint for percussive drilling between a female portion according to the present invention and another conventional rock drilling rod in cross-section.

FIG. 6 shows an enlarged portion of the threaded joint according to the present invention in FIG. 1.

FIG. 7 shows an enlarged portion of an alternative thread joint according to the present invention in cross-section corresponding FIG. 6.

FIG. 8 shows an alternative thread joint for percussive drilling according to the present invention in cross-section.

### DETAILED DESCRIPTION OF PREFERRED EMBODIMENTS OF THE INVENTION

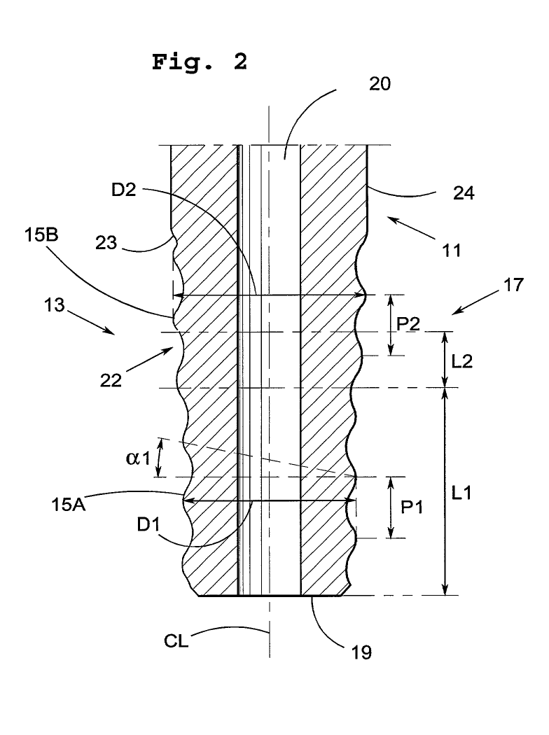

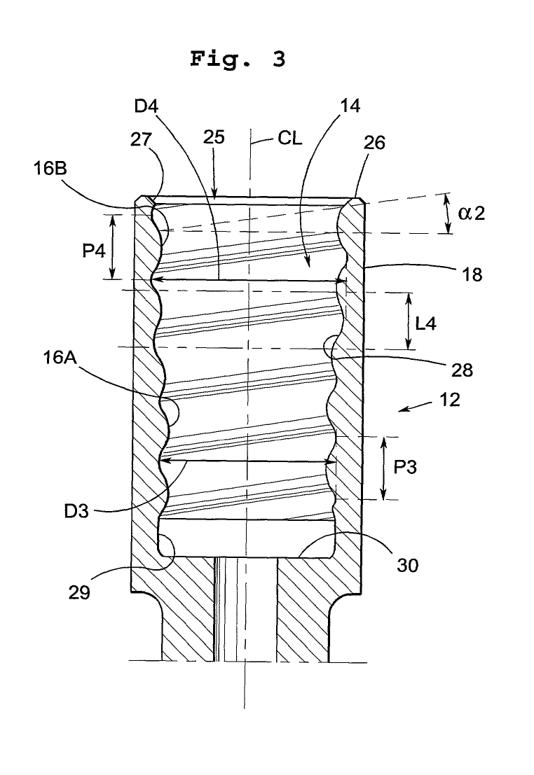

In FIGS. 2 and 3 are shown respective ends of two rock drilling rods 11, 12 according to the present invention. A first drill rod 11 includes a portion 13 with first and second substantially cylindrical male threads 15A, 15B, and a second drill rod 12 includes a portion 14 with substantially cylindrical female threads 16A, 16B. Both types of ends are provided on one and the same rod so that a series of identical rods can be interconnected to form a drill string. The drill string is intended to support a rock drill bit at its front end for percussive drilling during simultaneous rotation of the drill bit. The drill bit is frequently provided with cutting buttons formed of hard material (e.g., carbide). The drill rod has a center line CL.

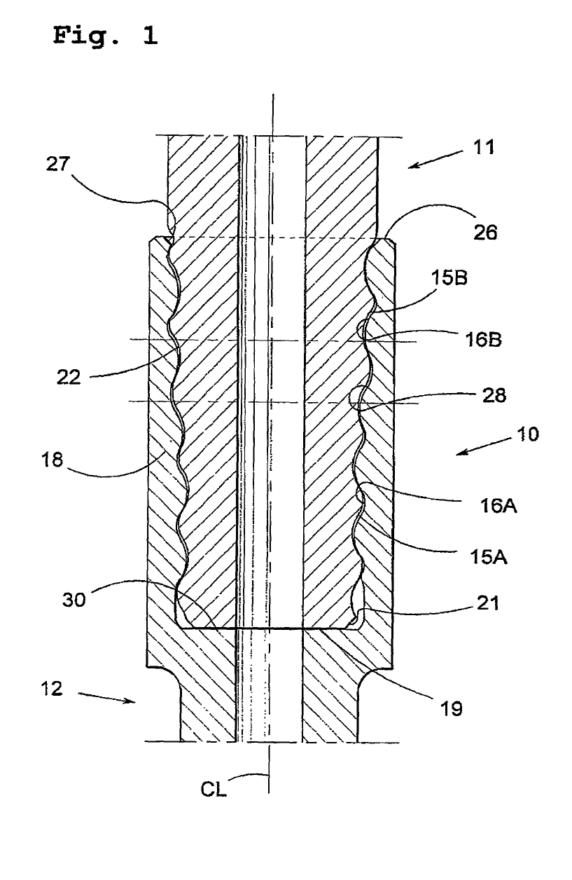

The portion 13 with first and second male threads 15A, 15B forms a spigot 17, which constitutes an integral part of the first drill rod, see FIG. 2. The drill rod 11 has an abutment surface 19 provided at the free end of the spigot 17. A central flush channel 20 that terminates in the abutment surface 19 extends through the entire drill string. The abutment surface 19 connects radially outwardly to a circumferential conical part 21, see FIG. 1. An entrance of a first male thread 15A starts in, or in the proximity of, the conical part 21 and extends axially upwardly in left-hand turns with a pitch P1. The first thread 15A has an outer diameter D1 with a magnitude of 26-40 mm and an axial length L1 with a magnitude of 20-50 mm.

The spigot 13 includes a transition area 22 at which the cylindrical threads 15A, 15B meet to form a continuous thread structure. The diameter of the spigot increases substantially step wise with a maintained pitch angle ∝1, to the second male thread 15B. The transition area 22 has an axial length L2 which is, at most, 2 times the biggest pitch of the joint. The second male thread 15B ends in an exit in, or in the vicinity of, a shoulder 23, which in turn connects to the jacket surface 24 of the rod 11. Also the second male thread 15B extends axially upwardly in left-hand turns with a pitch P2 from the transition area 22. The pitches P1 and P2 are substantially identical. The second thread 15B has an outer diameter D2 with a magnitude of 29-43 mm and an axial length in the magnitude of 20-50 mm. The respective dimensions of the diameters D1, D2 of the respective thread 15A, 15B differ from one another by at least 1 mm, preferably within an interval 2-5 mm and the difference is most preferably about 3 mm. In a preferred embodiment, D1 is about 28 mm and D2 is about 31 mm.

The portion 14 with first and second female threads 16A, 16B is provided in a recess 25 in a female portion or extension sleeve 18, which constitutes an integral part of the second drill rod 12, see FIG. 3. The drill rod 12 has an end surface 26 at the free end of the sleeve 18. The central flush channel 20 that via the recess 25 terminates at the end surface 26, extends through the entire drill string. The end surface 26 connects radially inwardly to a circumferential conical entrance bevel 27. An entrance of the second female thread 16B starts in or in the vicinity of the conical entrance bevel 27 and extends axially downwardly in the recess 25 in left-hand turns with a pitch P4. The second thread 16B has an outer diameter D4 with a magnitude of 29-43 mm and an axial length with a magnitude of 20-50 mm.

The recess 25 comprises a transition area 28 at which the cylindrical threads 16A, 16B meet to form a continuous thread structure. The diameter of the recess is changed or is reduced substantially stepwise at a maintained pitch angle ∝2, to a first female thread 16B. The transition area 28 has an axial length L4 which is, at most, 2 times the biggest pitch in the joint. The first female thread 16A ends in a thread clearance 29 in the vicinity of an abutment surface or bottom 30. Also the first female thread 16A extends axially downwardly in left-hand turns with a pitch P3 from the transition area 22. The pitches P3 and P4 are substantially identical and so are the pitch angles ∝1 and ∝2. The first thread 16A has an outer diameter D3 with a magnitude of 26-40 mm and an axial length with a magnitude of 20-50 mm. The respective dimensions of the diameters D3, D4 of the threads 16A, 16B differ from one another by at least 1 mm. Preferably the difference is within the interval 2-5 mm and is most preferably about 3 mm. In a preferred embodiment D3 is about 28 mm and D4 is about 31 mm.

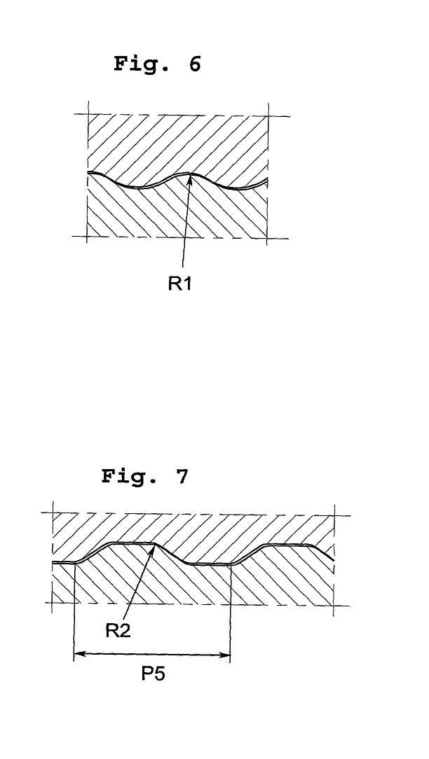

To form a threaded joint 10 from the two drill rods 11, 12 for percussive drilling shown in FIG. 1, the conical part 21 of the spigot 17 enters the bevel 27 of the free end surface 26 of the female portion. The rods are brought still further together in the axial direction (no rotation necessary) and the first male thread 15A slides past the second female thread 16B without creating a threaded engagement between these parts. It is only when the first male thread 15A reaches the diametrically smaller first female thread 16A that the threaded engagement occurs. About simultaneously, an engagement occurs between the second male thread 15B and the second female thread 16B. Then the rods are rotated relative to each other until the abutment surface 19 of the spigot abuts against the bottom 30 of the recess. The full cross-sectional profiles of the threads 15A, 15B and 16A, 16B are of conventional form, preferably rope or round (FIG. 6) or trapezoid (FIG. 7), such that abutments occur only between certain flank portions of the respective male and female portions when they have been tightened. (A “full” profile differs from a tapering or diminishing profile as the thread approaches its ends.) Each male and female thread has a full profile that includes a radius R1 (FIG. 6), or R2 (FIG. 7) that is greater than 0.1 times a pitch P1-P5 of the thread. In the case of the trapezoidal thread, a so-called T38 thread, R2 is 2 mm and the pitch P5 is 15.63 mm, whereby the ratio of radius to pitch becomes 0.13. Standard charts define a full profile.

In a tightened joint of trapezoidal threads there can be a gap of maximum 1.5 mm between the cooperating abutment surfaces of two flanks at a cylindrical portion, which gap will be gradually worn to zero.

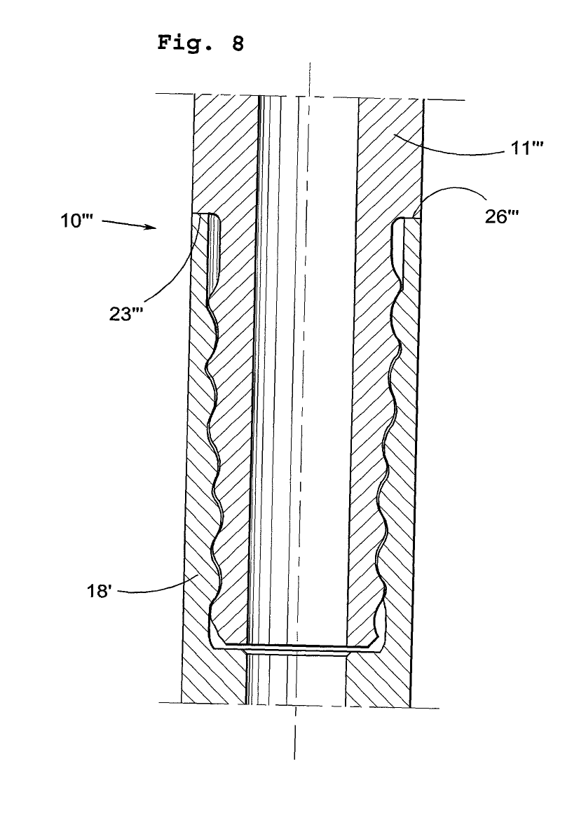

The joint in U.S. Pat. No. 4,968,068, the disclosure of which patent hereby is incorporated by reference into the present description, shows an alternative thread joint 10′″ (FIG. 8) in which the present invention can be utilized, wherein there exists a shoulder and/or bottom abutment between the rods 11′″, 12′″.

The through-going flush channel 20 of the drill rod conducts a flush medium, generally air or water. The sections having the smallest diameter D1 and D3 of the female thread and male thread, respectively, each comprises at least one thread turn with a full profile. One thread turn extends 180°. The transition area 22, 28 between the cylindrical sections at the respective thread has an axial extension L2, L4 which is at least one half of the diametrical difference between the smallest diameter D1, D3 and the biggest diameter D2 and D4. Said transition areas may be wholly spaced from each other in a tightened joint.

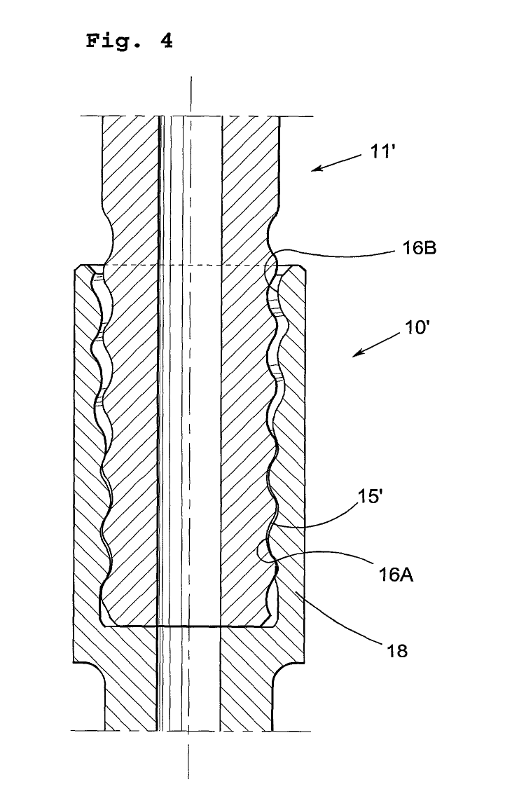

The female portion 18 or the spigot 17 according to the present invention may be used for example in a rock drill bit, whereby conventional rock drilling rods with simple cylindrical threads already stocked by the user may hold the rock drill bit. As an illustration of the latter, an alternative thread joint 10′ is shown in FIG. 4 where a spigot of a conventional rock drilling rod 11′ has been mounted to a female portion 18 according to the present invention. In this joint there is engagement between the first female thread 16A and a conventional cylindrical male thread 15′. However, the second female thread 16B is not utilized, i.e. there exists a radial gap between the thread tips of the male thread 15′ and the female thread 16B in a tightened joint.

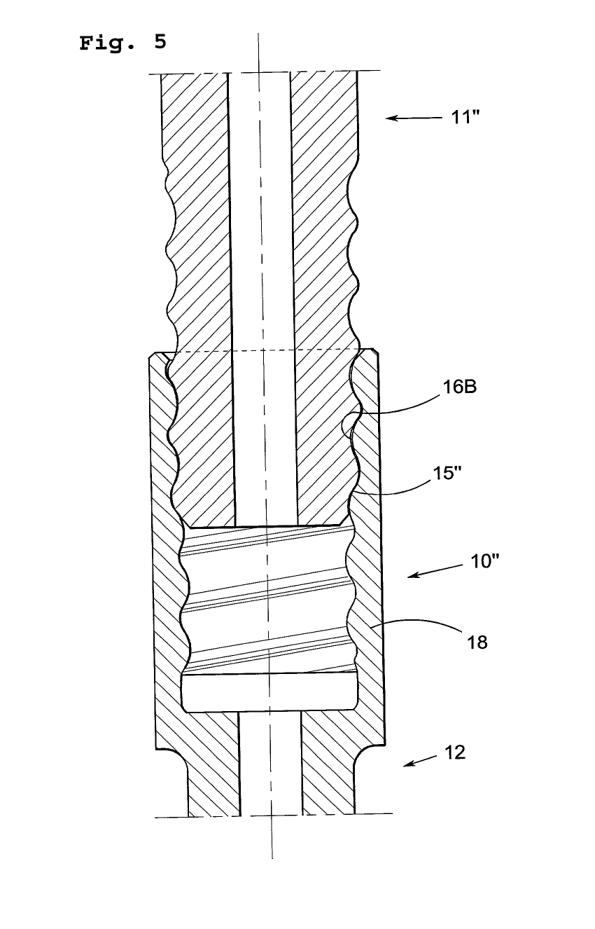

FIG. 5 illustrates still another alternative thread joint 10″ where a spigot of a conventional rock drilling rod 11″ has been mounted to a female portion 18 according to the present invention. In this joint there is engagement between the second female thread 16A and a coarser conventional cylindrical male thread 15′. The first female thread 16A however is not utilized, i.e. the male thread 15″ and the female thread 16B must transfer all shock waves in a tightened joint. The latter joint is intended to be used during easy drilling in soft rocks. It is of course possible to instead provide the drill bit with a portion having male threads within the idea of the present invention.

Consequently, a thread joint for percussive drilling and parts therefor according to the present invention bring about that the parts according to the present invention can be combined with conventional rock drilling components in an economically advantageous manner with a minimum of parts. Furthermore, the strength of the joint has been improved for a given outer diameter. In addition, more threads than two, maximum 4 cylindrical threads, can be provided at a portion 13, 14.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

What is claimed is:

1. A thread joint for percussive rock drilling, comprising first and second drill string components,
the first component including a male portion defining an integral spigot, the spigot including an abutment surface at a free end thereof and a male thread structure comprising first and second interconnected cylindrical male threads, the first and second male threads having different respective diameters and being interconnected by a male transition thread region;
the second component including a female portion defining an integral sleeve of the second component, the sleeve including an internal abutment surface and a female thread structure receiving the male thread structure, the female thread structure including first and second interconnected cylindrical female threads, the first and second female threads having different respective diameters and being interconnected by a female transition thread region.

2. The thread joint according to claims 1 wherein the diameter of the second female thread is larger than the diameter of the first female thread, the sleeve including a free end defining an entrance of the second female thread, the first male thread having its inlet disposed at free end of the spigot, the diameter of the first male thread being smaller than the diameter of the second female thread.

3. The thread joint according to claim 2 wherein each of the first and second male and female threads has a full profile and a radius which is larger than 0.1 times a pitch of the respective thread.

4. The thread joint according to claim 1 wherein the first and second male threads have equal pitches, and the first and second female threads have equal pitches.

5. The threads joint according to claim 1 wherein each of the first and second male threads and the first and second female threads have trapezoidal cross sections, there existing a maximum gap of 1.5 mm between mutually facing thread blanks in a tightened joint.

6. The thread joint according to claim 1 wherein the diameters of the first and second male threads differ by at least 1 mm, and the diameter of the first and second female threads differ by at least 1 mm.

7. The thread joint according to claim 1 wherein the diameters of the first and second male threads differ by 2 to 5 mm, and the diameters of the first and second female threads differ by 2-5 mm.

8. The thread joint according to claim 1 wherein the diameters of the first and second male threads differ by substantially 3 mm, and the diameter of the first and second female threads differ by substantially 3 mm.

9. The thread joint according to claim 1 wherein the one of the first and second male threads having the smaller diameter, comprising at least one turn at full profile; and the one of the first and second female threads having the smaller diameter, comprising at least one turn at full profile.

10. The thread joint according to claim 9 wherein the male transition region has an axial extension of at least one-half of a difference between the diameter of the fist and second male threads, the female transition region having an axial extension of at least one-half of a difference between the diameters of the first and second female threads.

11. The thread joint according to claim 10 wherein the male transition region is spaced from the female transition region.

12. A drill string component for percussive rock drilling comprising a male portion defining an integral spigot of the component, the spigot including an abutment surface at a free end thereof, and a male thread structure comprising first and second interconnected cylindrical male threads, the first and second male threads having different respective diameters and being interconnected by a male transition thread region.

13. A drill string component for percussive rock drilling comprising a female portion defining an integral sleeve of the component, the sleeve including an integral abutment surface and a female thread surface, the female thread structure including first and second interconnected cylindrical threads, the first and second female threads having different respective diameters and interconnected by a female transition thread structure.
